(19) United States
(12) Patent Application Publication
(10) Pub. No.: US 2010/0192812 A1
(43) Pub. Date: Aug. 5, 2010

(54) FOLDABLE BAR TABLE

(76) Inventors: Lee Pil Yul, Xiamen (CN); Huang Changjiu, Xiamen (CN)

Correspondence Address: Patent Docket Department;Armstrong Teasdale LLP, One Metropolitan Square, Suite 2600, St. Louis, MO, 63102-2740, US

(21) Appl. No.: 12/643,699

(22) Filed: Dec. 21, 2009

(30) Foreign Application Priority Data
Dec. 26, 2008 (CN) 200820229642.9

(51) Int. Cl. A47B 3/06; B23P 11/00; A47B 13/08; A47B 37/00

(52) U.S. Cl. 108/50.11; 29/428; 108/158.11; 108/157.17; 108/64

(57) ABSTRACT

A foldable bar table includes a support frame movable between a folded configuration and an extended configuration. The support frame includes a plurality of upright posts. A linkage couples two neighboring upright posts of the plurality of upright posts. The linkage includes a fix-connecting holder fixedly coupled to a respective upright post of the plurality of upright posts. The fix-connecting holder forms a first transverse groove. A cross rod is removably positionable within the first transverse groove to facilitate maintaining the support frame in the extended configuration. A panel unit is coupled to the at least one cross rod.

### CROSS REFERENCE TO RELATED APPLICATIONS

This application claims the benefit of Chinese Patent Application No. 200820229642.9 filed on Dec. 26, 2008, which is hereby incorporated by reference in its entirety.

### BACKGROUND

The subject matter described herein relates generally to a foldable or collapsible bar counter or table.

At least some conventional foldable bar counters and foldable tables include a support frame and two cross rods. The support frame has four upright posts and is movable between a folded configuration and an unfolded configuration. Two neighboring upright posts are connected by scissor-like linkages. A sliding holder is slidably coupled to the upright posts, and a holder is fixedly coupled on a top end of each upright post. The scissor-like linkages are coupled between the holder of neighboring upright posts and the sliding holder. An additional locking mechanism is configured to lock the relative position of the upright post and the sliding holder to keep the support frame in unfolded configuration or to release the lock connection between the upright post and the sliding holder to allow the sliding holder to slide freely along the upright post toward the folded configuration. The locking mechanism includes a V-shaped spring nail and a hole defined in the upright post. The spring nail is fixed inside the upright post and has a lock-connecting post. The lock-connecting post is biased to pass through the hole and extend outwardly from the upright post. The section that extends outwardly from the upright post supports the sliding holder to prevent the sliding holder from sliding down to facilitate the lock-connection.

The additional lock-connecting mechanism required to maintain the bar table in the unfolded configuration increases the cost of manufacture and sale of the support device. Further, the springing nail is set inside the upright post, resulting in inconvenient and inefficient assembly as well as increased assembly cost. Additionally, the hole must be drilled in the upright post, which not only increases processing cost, but may also reduce the strength of upright post. Finally, in order to fold the support device, the cross rod has to be disassembled, the lock-connecting post must be pressed inwardly into the upright post, and the sliding holder must slide along the upright post. These multiple steps lead to inconvenience while folding the table bar.

### BRIEF DESCRIPTION

In one aspect, a foldable bar table includes a support frame that is movable between a folded configuration and an extended configuration. The support frame includes a plurality of upright posts and a linkage coupling two neighboring upright posts of the plurality of upright posts. The linkage includes a fix-connecting holder fixedly coupled to a respective upright post of the plurality of upright posts. Each fix-connecting holder forms a first transverse groove. At least one cross rod is removably positionable within the first transverse groove to facilitate maintaining the support frame in the extended configuration. A panel unit is coupled to the at least one cross rod.

In another aspect, a foldable table includes a support frame that is movable between a folded configuration and an extended configuration. The support frame includes a plurality of upright posts coupled by a plurality of scissor-like linkages. A fix-connecting holder is coupled to a respective end of each upright post of the plurality of upright posts. The fix-connecting holder forms a first transverse groove. A cross rod is positionable within the first transverse groove ad a panel is coupled to the cross rod.

In a further aspect, a method for assembling a foldable table includes moving a support frame from a folded configuration to an extended configuration. The support frame includes a plurality of upright posts coupled by a plurality of scissor-like linkages. A fix-connecting holder is coupled to a respective end of each upright post of the plurality of upright posts. The fix-connecting holder forms a first transverse groove. A cross rod is positioned within the first transverse groove and a panel is coupled to the cross rod.

### BRIEF DESCRIPTION OF THE DRAWINGS

FIG. 1 is a perspective view of an exemplary bar counter or table;

FIG. 2 is an exploded perspective view of the exemplary bar table shown in FIG. 1 with a support frame of the bar table in an assembled configuration;

FIG. 3 is a perspective view of the bar table shown in FIG. 1 in a partially assembled configuration;

FIG. 4 is a perspective view of the bar table shown in FIG. 1 in a partially assembled configuration;

FIG. 5 is a plan view of the support frame of the bar table shown in FIG. 1 in a folded configuration;

FIG. 6 is an enlarged perspective view of a portion A of the bar table shown in FIG. 2 in a partially assembled configuration;

FIG. 7 is an enlarged perspective view of a portion B of the bar table shown in FIG. 2 in a partially assembled configuration;

FIG. 8 is an enlarged perspective view of a portion C of the bar table shown in FIG. 2 in a partially assembled configuration;

FIG. 9 is an exploded perspective view of an exemplary bar table; and

FIG. 10 is an enlarged perspective view of a portion D of the bar table shown in FIG. 9 in a partially assembled configuration.

### DETAILED DESCRIPTION

A foldable or collapsible bar counter or table as described herein includes a support frame that is movable between a collapsed or folded configuration, to facilitate transporting and/or storing the bar counter or table, and an extended configuration to support a counter or table assembly. The bar counter or table also includes at least one cross rod. The support frame includes a plurality of upright posts, such as at least four upright posts. Adjacent or neighboring upright posts are coupled by one or more scissor-like linkages. The cross rod is detachably or removably coupled to the support frame with the bar counter or table in an assembled configuration. Opposing ends of the cross rod rest against the two coupled upright posts to maintain the support frame in the extended configuration. As such, the cross rod not only couples the upright posts, but also provides a locking mechanism for the support frame. Therefore, the lock-connecting mechanism of conventional bar counters or tables is not necessary and assembly time and cost are reduced. The embodiments described below is directed to a foldable or collapsible bar table that includes a foldable support frame, one or more cross rods removably coupled to the support frame, and a panel unit either fixedly coupled or removably coupled to the cross rods. It should be apparent to those skilled in the art that, although the following description is directed to a foldable or collapsible bar table, the embodiments described herein are also suitable for use in manufacturing and/or assembling a foldable or collapsible bar counter.

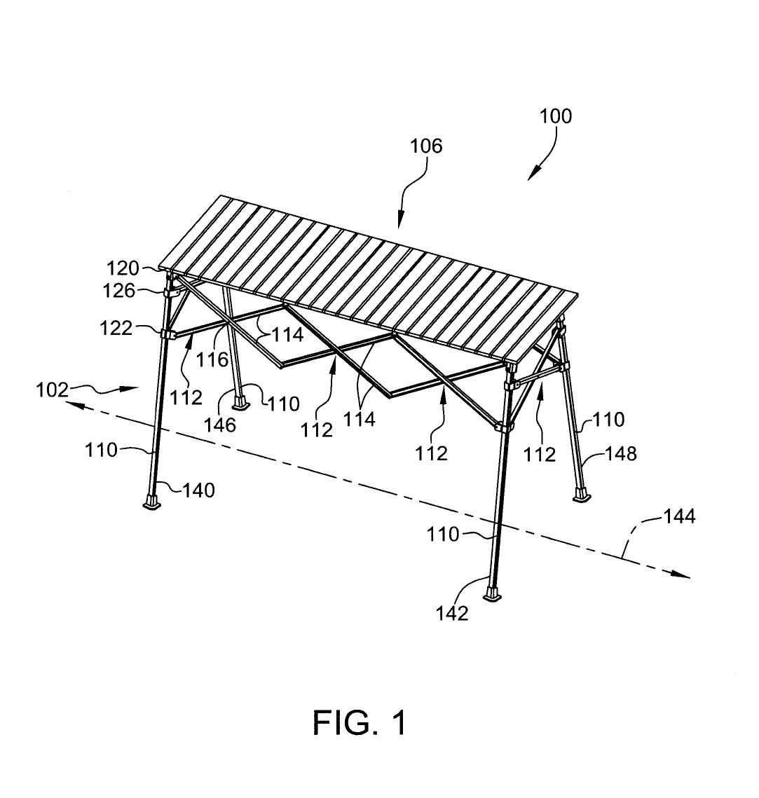

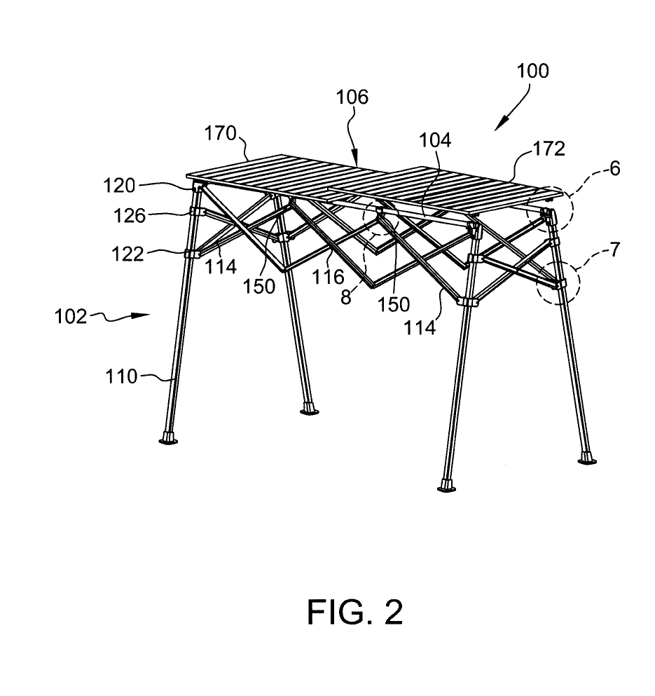

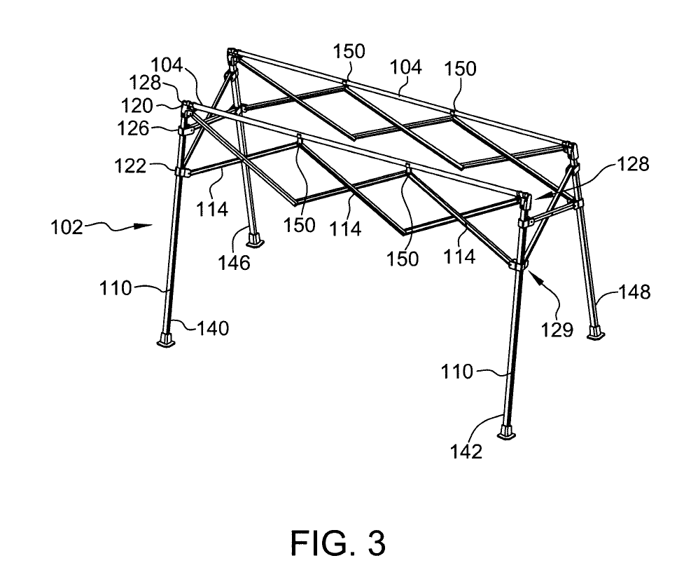

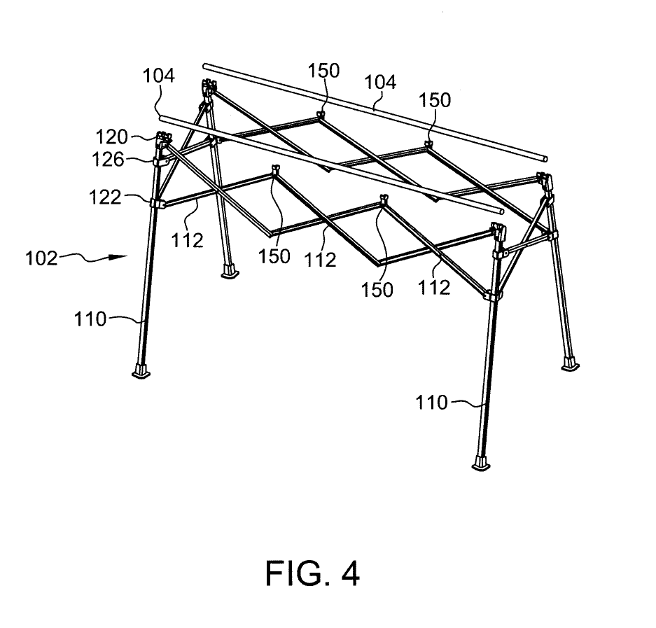

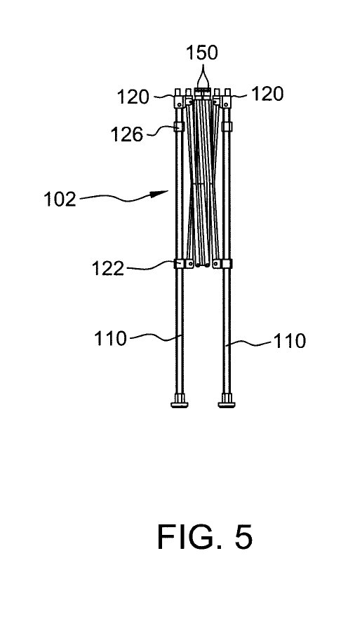

Referring to the figures, and particularly to FIG. 1, FIG. 2, FIG. 3 and FIG. 4, a foldable bar table 100 includes a support frame 102, one or more cross rods 104 and a panel unit 106. In the exemplary embodiment, support frame 102 includes four upright posts 110 having an adjustable length. As shown for example in FIG. 1, upright posts 110 are arranged in a quadrilateral. Two neighboring upright posts 110 are coupled by one or more scissor-like linkages 112. In the exemplary embodiment, linkages 112 include two connecting rods 114 and a pin 116 pivotally coupling connecting rods 114 together at a center of connecting rods 114 so that support frame 102 is collapsible or foldable from an extended configuration, as shown in FIGS. 1-4, to a folded configuration, as shown in FIG. 5.

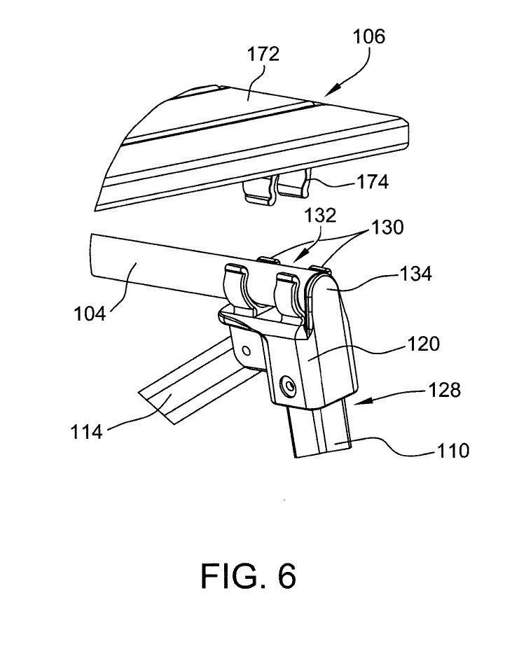

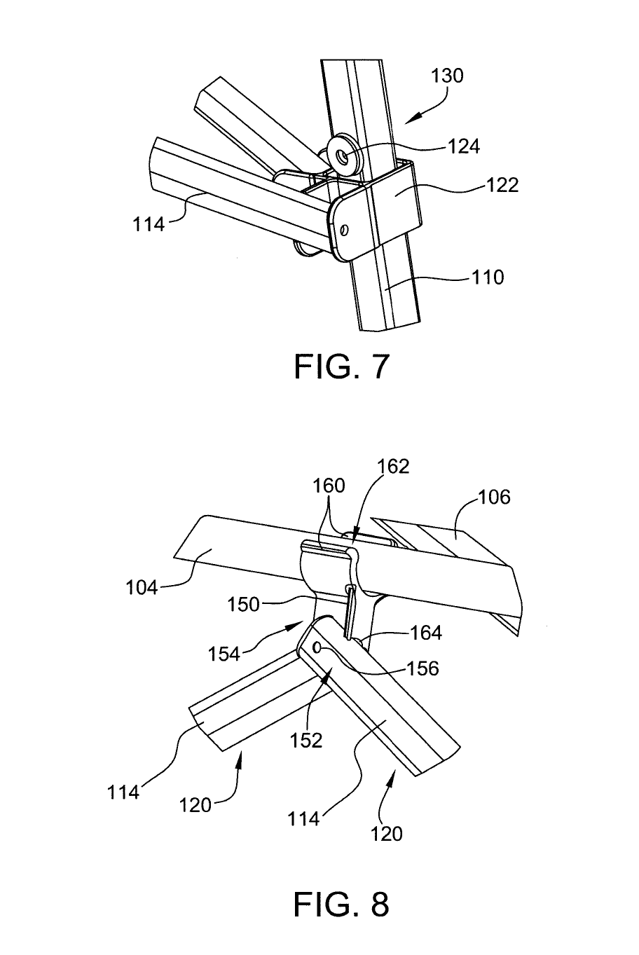

Referring to FIG. 3, FIG. 4, FIG. 6 and FIG. 7, a first fix-connecting holder 120, a sliding holder 122, a limit holder 124 to limit movement of sliding holder 122 along upright post 110, and a second fix-connecting holder 126 are position about and/or coupled to a respective upright post 110. First fix-connecting holder 120, as shown in FIG. 3, is fixedly coupled to a top end 128 of upright post 110 and limit holder 124, as shown in FIG. 7, is fixedly coupled to a middle portion 129 of upright post 110. Sliding holder 122 is slidably coupled about upright post 110 and beneath limit holder 124 and is configured to slide along a length of upright post 110. As shown for example in FIG. 6, first fix-connecting holder 120 includes upwardly extending brackets 130 that cooperatively form a first transverse groove 132 configured or sized to receive cross rod 104. First fix-connecting holder 120 also includes an end-prop piece 134. Referring to FIG. 6, transverse grooves 132 are arranged laterally in a parallel direction with a distance between them, and end-prop piece 134 directly faces and is situated outside transverse groove 132. In an alternative embodiment, end-prop piece 134 is set on an outer end of transverse groove 132.

In the exemplary embodiment, support frame 102 includes four upright posts 110 described as a first upright post 140 and a second upright post 142 arranged linearly or in a row in a lateral direction 144 of support frame 102, and a third upright post 146 and a fourth upright post 148 arranged linearly or in a row in the lateral direction 144 of support frame 102, as shown in FIG. 1. Support frame 102 may include any suitable number of linkages 112 between cooperating upright posts 110 arranged laterally in a row (i.e., between first upright post 140 and second upright post 142, and between third upright post 146 and fourth upright post 148). In the exemplary embodiment shown in FIG. 1, support frame 102 include three linkages 112 coupled in series, and coupled between first fix-connecting holder 120 and sliding holder 122 of respective upright posts 110.

In certain embodiments, one or more support holders 150 are coupled at an upper joint 152 of neighboring linkages 112. Referring to FIG. 8, upper ends of connecting rods 114 of two neighboring linkages 112 are coupled at upper joint 152. A base portion 154 of support holder 150 is positioned between connecting rods 114 and a pivot shaft 156 extends through the upper ends of connecting rods 114 and support holder 150 to couple the two upper ends such that support holder 150 is rotatably or pivotally coupled at upper joint 152. Support holder 150 includes upwardly extending brackets 160 that cooperatively form a second transverse groove 162 configured or sized to receive cross rod 104. In a particular embodiment, support holder 150 forms a shoulder, a projection, and/or a groove 164 to facilitate establishing a contact relationship between support holder 150 and respective connecting rods 114 with support frame 102 in the extended configuration. When support frame 102 is in the extended configuration, support holder 150 is rotatable to position groove 164 to transfer a force imposed on cross rod 104 to connecting rods 114 directly, and reduce the force on pivot shaft 156, thereby prolonging service life.

As shown in FIG. 1 for example, one linkage 112 is positioned between upright posts 110 on lateral sides of support frame 102 (i.e., between first upright post 140 and third upright post 146, and between second upright 142 post and fourth upright post 148). Linkage 112 is coupled between second fix-connecting holder 126 and sliding holder 122 of upright posts 110.

Referring to FIG. 3, FIG. 4 and FIG. 6, cross rods 104 are coupled separately to respective upright posts 110. In the exemplary embodiment, one cross rod 104 is coupled to first upright post 140 and second upright post 142 arranged laterally, and one cross rod 104 is coupled to third upright post 146 and fourth upright post 148. In a particular embodiment, each cross rod 104 includes two detachable short rods. In certain embodiments, the two short rods are telescoping rods with one end of each short rod having a plugging end and an opposing plugged end. The plugging end of one short rod is plugged into the plugged end of the other short rod. An elastic rope couples the two short rods. Cross rod 104 is detachably or removably coupled to support frame 102. With support frame 102 in the extended configuration, cross rod 104 is positioned within each first transverse groove 132 of each cooperating first fix-connecting holder 120 and within each second transverse groove 162 of cooperating support holders 150. With cross rod 104 in an assembled configuration, the opposing ends of cross rod 104 are propped separately against end-prop pieces 134 of first fix-connecting holders 120 to facilitate maintaining support frame 102 in the extended configuration. In one embodiment, a clamping mechanism is positioned between first transverse groove 132 and cross rod 104. With cross rod 104 removed from support frame 102, support frame 102 can be folded or moved to the collapsed or folded configuration.

Panel unit 106 includes one or more panel pieces. In one embodiment as shown in FIG. 2, panel unit 106 includes two panel pieces 170, 172 arranged side-by-side. In a particular embodiment, adjacent panel pieces 170, 172 are coupled together with one or more flexible and/or elastic connecting ropes (not shown). A suitable bracket 174, such as a compression bracket, shown in FIG. 6, is coupled to panel unit 106, such as to a bottom surface of panel piece 170, 172. Bracket 174 has suitable dimensions and is configured to be positioned between upwardly extending brackets 130 of first fix-connecting holder 120. Bracket 174 clamps onto cross rod 104 and is situated between upwardly extending brackets 130 such that panel unit 106 and cross rod 104 form a detachable connecting structure.

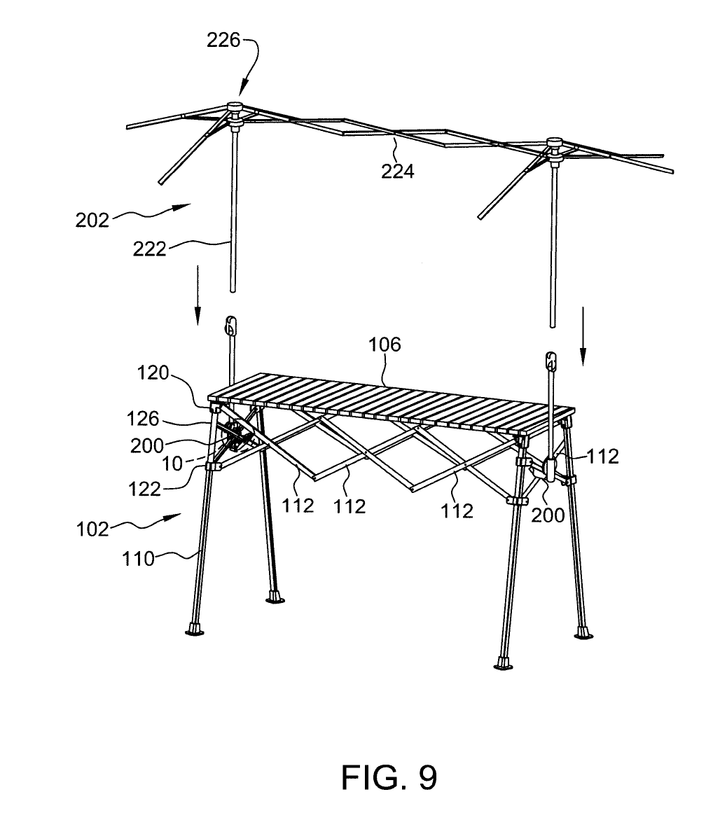

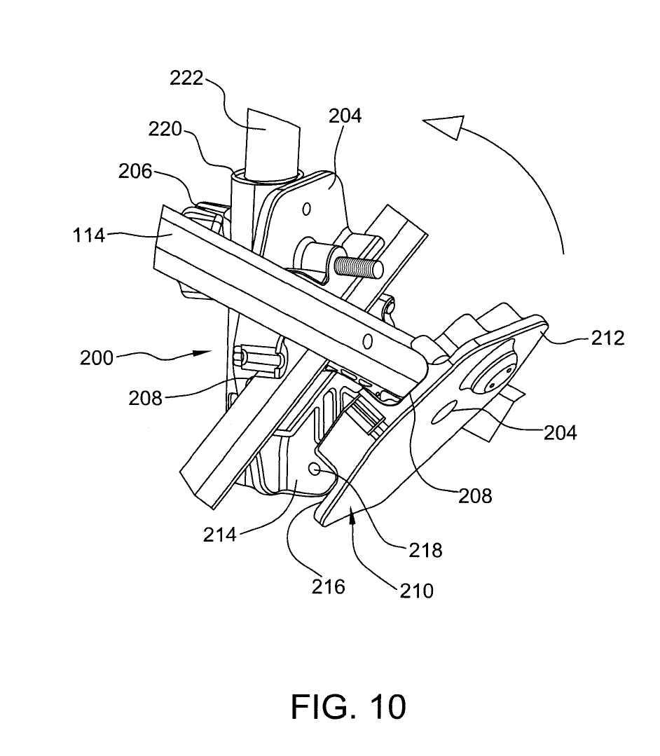

Referring to FIGS. 9 and 10, in one embodiment bar table 100 includes one or more connecting mechanisms 200 detachably or removably coupled to a respective linkage 112. Connecting mechanisms 200 are configured to support an awning 202. Connecting mechanism 200 includes connecting pieces 204 and a screw-connecting part 206. Connecting piece 204 has a locating groove 208 (which matches linkage 112), a pin-connecting section 210 and a lock-connecting section 212. Locating groove 208 is formed between pin-connecting section 210 and lock-connecting section 212. Pin-connecting section 210 of a first connecting piece 204 includes spacing lugs 214 formed on an inner surface of connecting piece 204. Pin-connecting section 210 of a second connecting piece 402 includes a middle lug 216 which is formed on an inner surface of connecting piece 402. Middle lug 216 is positioned between spacing lugs 214, and a pivot shaft 218 extends through spacing lugs 214 and middle lug 216 to rotatably couple connecting pieces 204 with the inner side faces of connecting pieces 204 facing each other. Locating grooves 208 of connecting pieces 204 face each other and cover connecting rods 114 of linkage 112. Screw-connecting part 206 penetrates one connecting piece 204 and lock-connects onto the other connecting piece 204 to couple connecting pieces 204 together, as well as to mount connecting mechanism 200 onto linkage 112.

A hole 220 is formed on connecting piece 204. Awning 202 includes one or more upright posts 222, and an awning frame 224 coupled between upright posts 222. A tarpaulin 226 is coupled to awning frame 224. In a particular embodiment, upright posts 222 include two telescoping or detachable short rods. Each upright post 222 is positionable within a respective hole 220 formed in connecting piece 204 to removably couple awning frame 224 to support frame 102.

In a particular embodiment, connecting mechanism 200 is removably coupled to linkage 112 and awning frame 224. In this embodiment, connecting mechanism 200 includes a clamp having two connecting pieces and an elastic part. Each connecting piece has a locating groove which matches the connecting rod of the linkage and a pin-connected section. The pin-connected sections of the two connecting pieces are pin-connected, and the locating grooves of the two connecting pieces face each other to cover and couple the two connecting rods of the linkage by the elastic action of the elastic part.

The foldable or collapsible bar counter or table described herein can be efficiently manufactured and assembled, thus reducing manufacturing costs and frustration and inconvenience during assembly. One or more technical solutions of the subject foldable or collapsible bar counter or table are provided. A foldable bar counter includes a support frame movable between a folded configuration and an extended configuration. The support frame includes a plurality of upright posts, with neighboring upright posts coupled by scissor-like linkages. A fix-connecting holder is fixedly coupled to each upright post. The fix-connecting holder has a first transverse groove with an upward opening and an end-prop piece directly facing towards the first transverse groove. At least one cross rod, which in an assembled configuration maintains the support frame in an extended configuration, is removably coupled to the support frame. When in the assembled configuration, the cross rod is positioned within the first transverse grooves of the first fix-connecting holders with both ends of the cross rod contacting and/or abutted against the end-prop pieces of the fix-connecting holders. A panel unit is fixedly or removably coupled to the cross rod.

A suitable number of linkages couple the neighboring upright posts. A support holder is positioned at a joint coupling neighboring linkages. The support holder forms a second transverse groove with an upward opening that passes through the support holder. The cross rod is positioned in the second transverse groove when in the assembled configuration. Each linkage includes two connecting rods with a pin connection at a center of the connecting rods. Upper ends of the connecting rods of neighboring linkages intercross with a distance between them, and the support holder is positioned between the two upper ends. A pivot shaft extends through the two upper ends and the support holder to couple the support holder to the connecting rods. In a particular embodiment, a contact-connecting groove with a downward opening is also formed on the support holder. The contact-connecting groove contacts or interferes with one or more upper ends of respective connecting rods when the support frame is in extended configuration.

The panel unit can be fixedly coupled to the cross bar or can be removably coupled to the cross bar. In one embodiment, the panel unit includes a plurality of parallel side-by-side panel pieces coupled together with a flexible or elastic connecting rope. Upwardly extending brackets of each first fix-connecting holder are spaced to receive a bracket coupled to a bottom surface of the panel unit. The panel unit bracket clamps to the cross rod and is positioned between the upwardly extending brackets of the first fix-connecting holder.

In one embodiment, one or more connecting mechanisms are removably coupled to the linkage. The connecting mechanism includes two connecting pieces and a screw-connecting part. The connecting piece forms a locating groove that matches the connecting rod of the linkage. The locating groove is formed between the pin-connecting section and the lock-connecting section. The pin-connecting sections of the two connecting pieces are pin-connected, and the locating grooves of the two connecting pieces face each other and cover the two connecting rods of the linkage. The lock-connecting sections of the two connecting pieces are connected by a screw-connecting part. In a particular embodiment, an awning is removably coupled to the connecting mechanism.

In one embodiment, at least one connecting mechanism is removably coupled to the linkage. The connecting mechanism includes a clamp having two connecting pieces and an elastic part. The connecting piece forms a locating groove (which matches the connecting rod) and a pin-connecting section. The pin-connecting sections of the two connecting pieces are pin-connected, and the locating grooves of the two connecting pieces face each other and cover the two connecting rods of the linkage by the elastic action of the elastic part. An awning is removably coupled to the connecting mechanism.

Because the ends of the cross rod are positioned against the two upright posts in the assembled configuration, a distance between the two upright posts can be maintained to facilitate maintaining the support frame in the extended configuration. The cross rod not only connects the panel unit to the support frame, but also is lock-connected with support frame. Therefore, the lock-connecting mechanism of the prior art is not required thereby reducing manufacturing cost. The support frame is easily folded with the lock-connection released while removing the cross rod. Further, there is no need to drill a hole in the upright post. When in the assembled configuration, the cross rod is positioned within the first transverse grooves of the fix-connecting holders with both ends abutted against the end-prop pieces of the fix-connecting holders. Therefore, the cross rod can be mounted firmly on the support frame. A support holder provides additional structural support for the cross rod, and is configured to disperse a force imposed to the upright post and the linkage. The support holder is rotatably coupled to the linkage. The panel unit may include several parallel side-by-side panel pieces coupled together with a connecting rope. The panel unit is easily foldable, making the panel unit compact, portable and easy to store. Further, the panel unit is coupled to the cross rod to prevent or limit relative transverse movement between the panel unit and the cross rod.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A foldable bar table comprising:
a support frame movable between a folded configuration and an extended configuration, said support frame comprising:
a plurality of upright posts; and
a linkage coupling two neighboring upright posts of said plurality of upright posts, said linkage comprising a fix-connecting holder fixedly coupled to a respective upright post of said plurality of upright posts, said fix-connecting holder forming a first transverse groove;
at least one cross rod removably positionable within said first transverse groove to facilitate maintaining said support frame in the extended configuration; and
a panel unit coupled to said at least one cross rod.

2. A foldable bar table in accordance with claim 1, wherein said fix-connecting holder comprises an end-prop piece that faces said first transverse groove, with said at least one cross rod positioned within said first transverse groove an end of said at least one cross rod contacting said end-prop piece.

3. A foldable bar table in accordance with claim 1, further comprising a support holder coupled to said linkage, said support holder forming a second transverse groove configured to receive said at least one cross rod.

4. A foldable bar table in accordance with claim 3, wherein said linkage comprises a first connecting rod pivotally coupled to a second connecting rod, said support holder coupled to an upper end of said first connecting rod.

5. A foldable bar table in accordance with claim 4, wherein said support holder forms a contact-connecting groove that contacts at least one connecting rod with said support frame in the extended configuration.

6. A foldable bar table in accordance with claim 1, wherein said panel unit is removably coupled to said at least one cross bar.

7. A foldable bar table in accordance with claim 6, wherein said panel unit comprises a plurality of panel pieces.

8. A foldable bar table in accordance with claim 1, further comprising a bracket coupled to said panel unit, said bracket positioned between upwardly extending brackets of said fix-connecting holder forming said first transverse groove and removably coupled to said at least one cross bar.

9. A foldable bar table in accordance with claim 1, further comprising at least one connecting mechanism removably coupled to said linkage, said at least one connecting mechanism comprising:
a first connecting piece forming a first locating groove matching at least one connecting rod of said linkage, a first pin-connecting section, and a first lock-connecting section, said first locating groove formed between said first pin-connecting section and said first lock-connecting section;
a second connecting piece forming a second locating groove matching at least one connecting rod of said linkage, a second pin-connecting section coupled to said first pin-connecting section, and a second lock-connecting section, said second locating groove formed between said second pin-connecting section and said second lock-connecting section; and
a screw-connecting part coupling said first lock-connecting section and said second lock-connecting section.

10. A foldable bar table in accordance with claim 9, further comprising an awning removably coupled to said at least one connecting mechanism.

11. A foldable bar table in accordance with claim 1, further comprising at least one connecting mechanism removably coupled to said linkage, said at least one connecting mechanism comprising a clamp comprising two connecting pieces and an elastic part, said two connecting pieces forming a locating groove and including a pin-connecting section, said pin-connecting sections of said two connecting pieces coupled together.

12. A foldable bar table in accordance with claim 11, further comprising an awning removably coupled to said at least one connecting mechanism.

13. A foldable table comprising:
a support frame movable between a folded configuration and an extended configuration, said support frame comprising a plurality of upright posts coupled by a plurality of scissor-like linkages, a fix-connecting holder coupled to a respective end of a respective upright post of said plurality of upright posts, said fix-connecting holder forming a first transverse groove;
a cross rod positionable within said first transverse groove; and
a panel coupled to said cross rod.

14. A foldable table in accordance with claim 13, further comprising a support holder coupled to a respective linkage of said plurality of scissor-like linkages, said support holder forming a second transverse groove configured to receive said cross rod.

15. A foldable table in accordance with claim 14, wherein each linkage of said plurality of scissor-like linkages comprises two pivotally coupled connecting rods, said support holder positioned between upper ends of said two connecting rods, and a pivot shaft extending through said upper ends and said support holder to pivotally couple said support holder to said linkage.

16. A foldable table in accordance with claim 15, wherein said support holder forms a contact-connecting groove with a downward opening configured to contact at least one upper end when said support frame is in the extended configuration.

17. A method for assembling a foldable table, said method comprising:
moving a support frame from a folded configuration to an extended configuration, the support frame comprising a plurality of upright posts coupled by a plurality of scissor-like linkages, a fix-connecting holder coupled to a respective end of each upright post of the plurality of upright posts, the fix-connecting holder forming a first transverse groove;
positioning a cross rod within the first transverse groove; and
coupling a panel to the cross rod.

18. A method for assembling a foldable table in accordance with claim 17, wherein the cross rod is removably positioned within the first transverse groove.

19. A method for assembling a foldable table in accordance with claim 17, wherein the panel is removably coupled to the cross rod.
